(19) United States
(12) Patent Application Publication
(10) Pub. No.: US 2014/0354389 A1
(43) Pub. Date: Dec. 4, 2014

(54) Compact step-programmable optimization of low-noise amplifier signal-to-noise

(71) Applicant: Richard Cliff, Melbourne, FL (US)

(72) Inventor: Richard Cliff, Melbourne, FL (US)

(21) Appl. No.: 13/905,198

(22) Filed: May 30, 2013

(51) Int. Cl. H01F 29/00; F16H 21/44

(52) U.S. Cl. CPC H01F 29/00; F16H 21/44
USPC 336/149; 74/88

(57) ABSTRACT

A new family of programmable low-noise RF impedance transformers has been developed. These new transformers can be configured and operated to compensate for variable antenna output impedance. This enables better optimization of RF receiving-system SNR. For some applications, these new devices can be more compact and less expensive than any previously available.

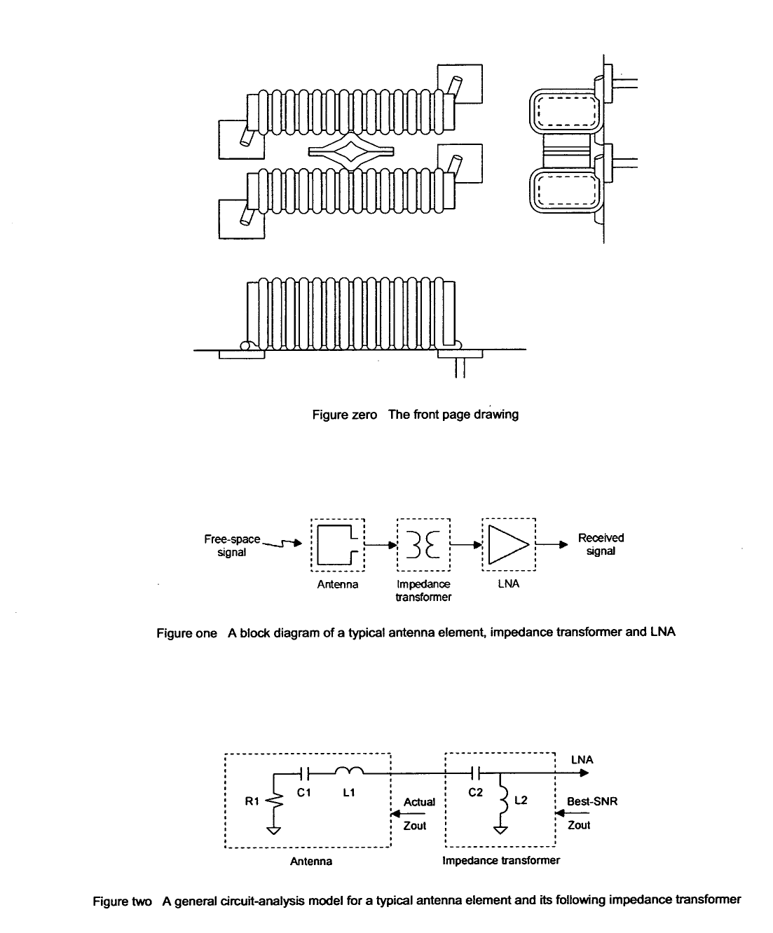

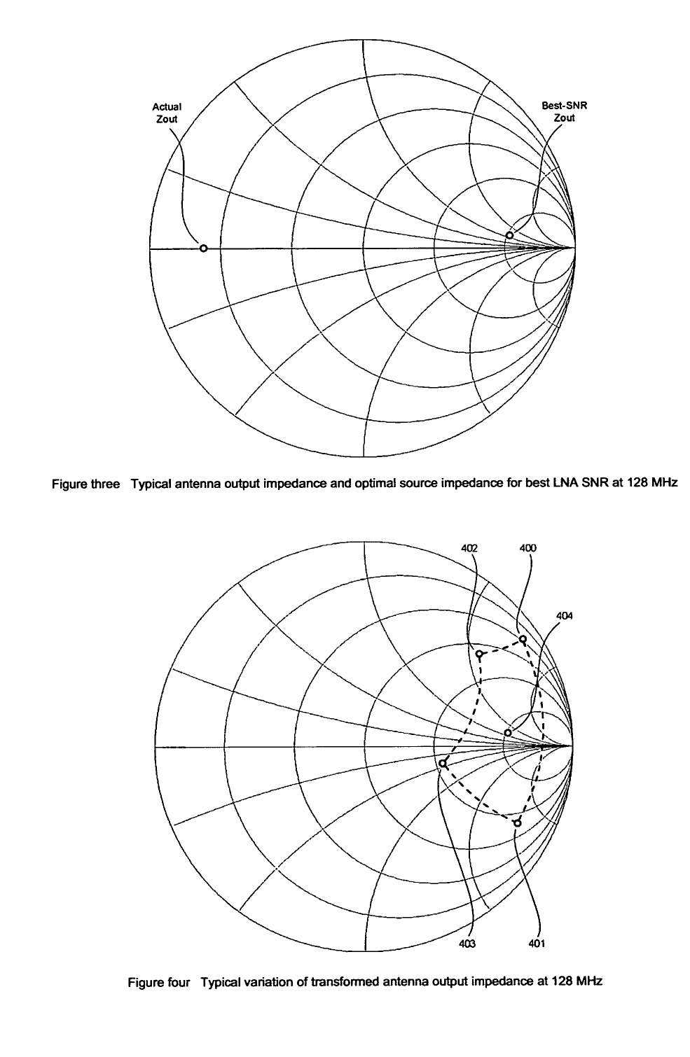

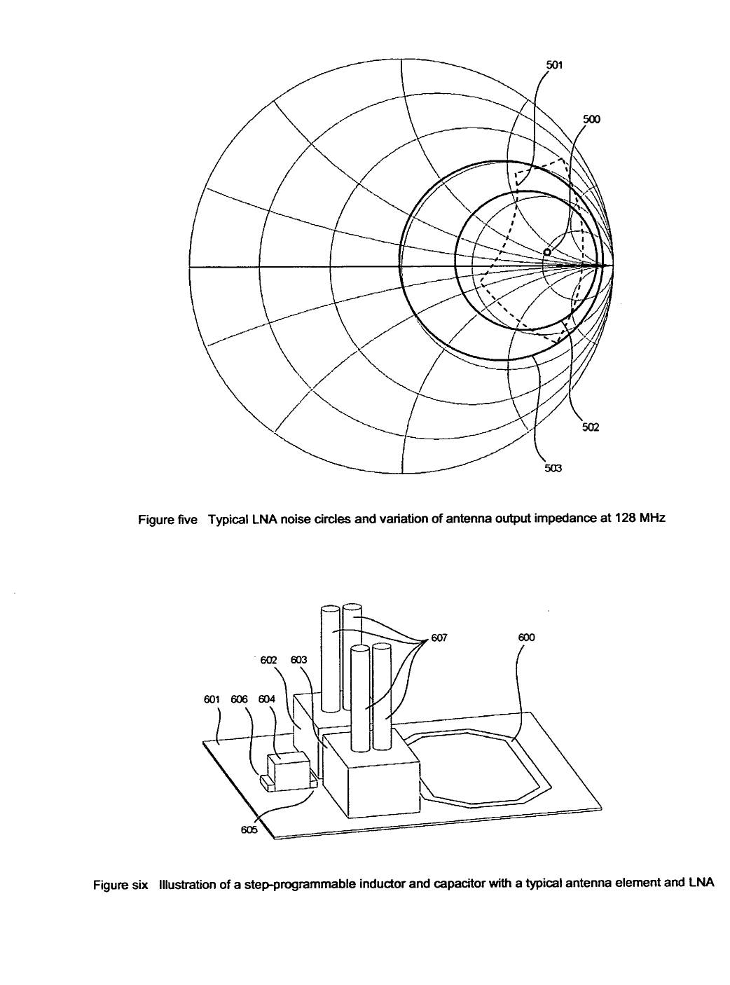

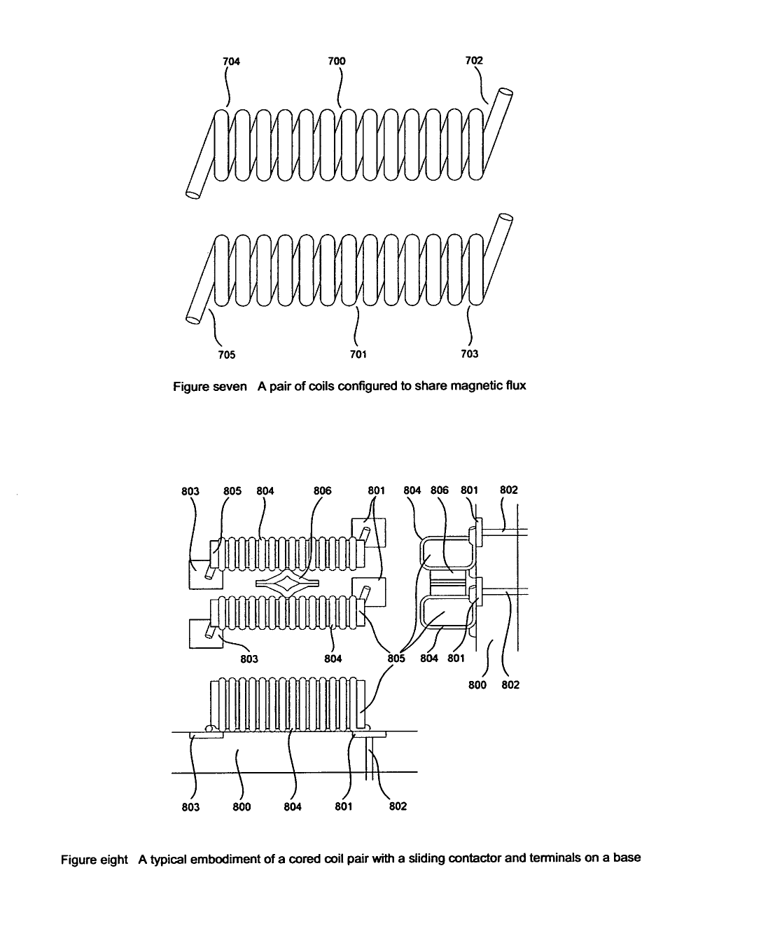

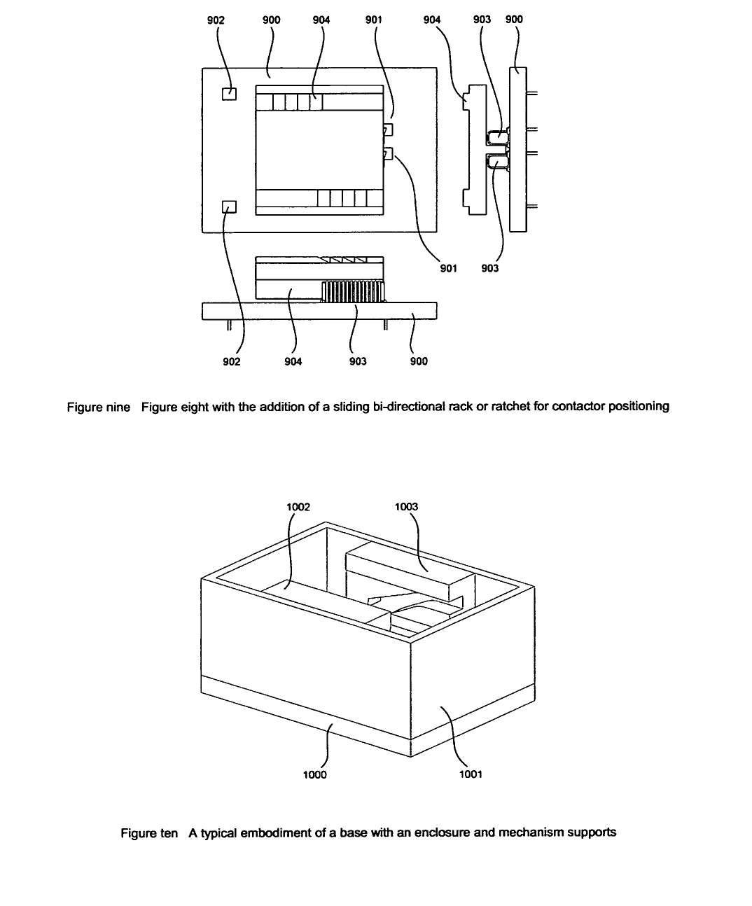

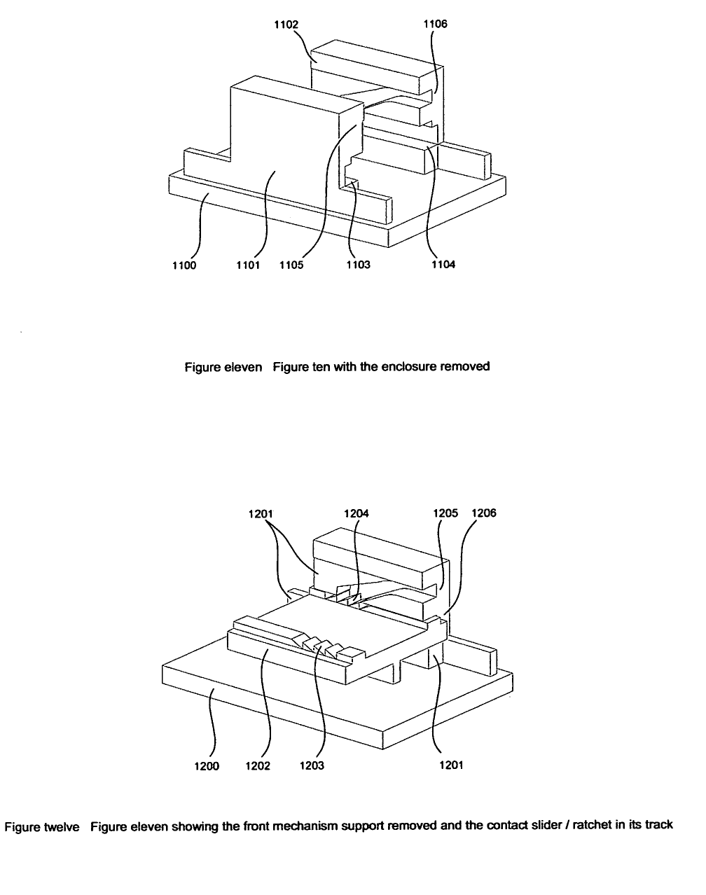

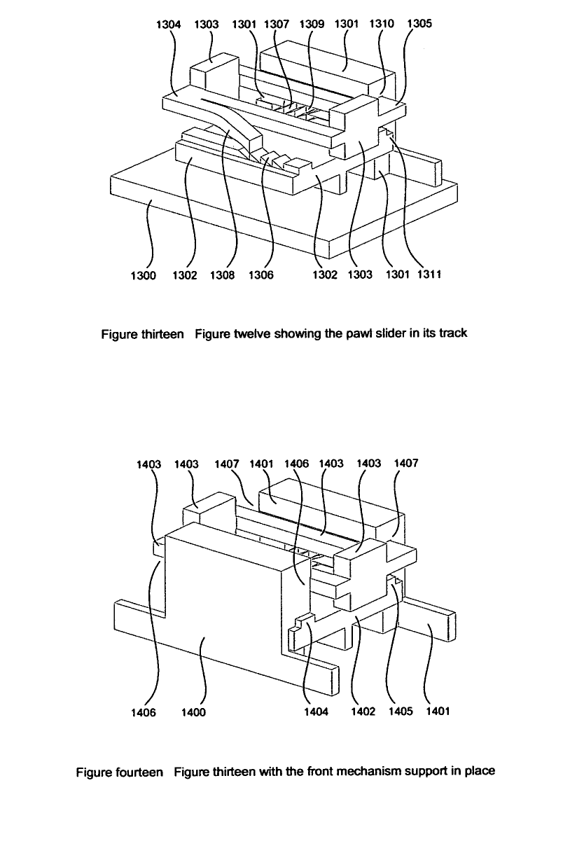

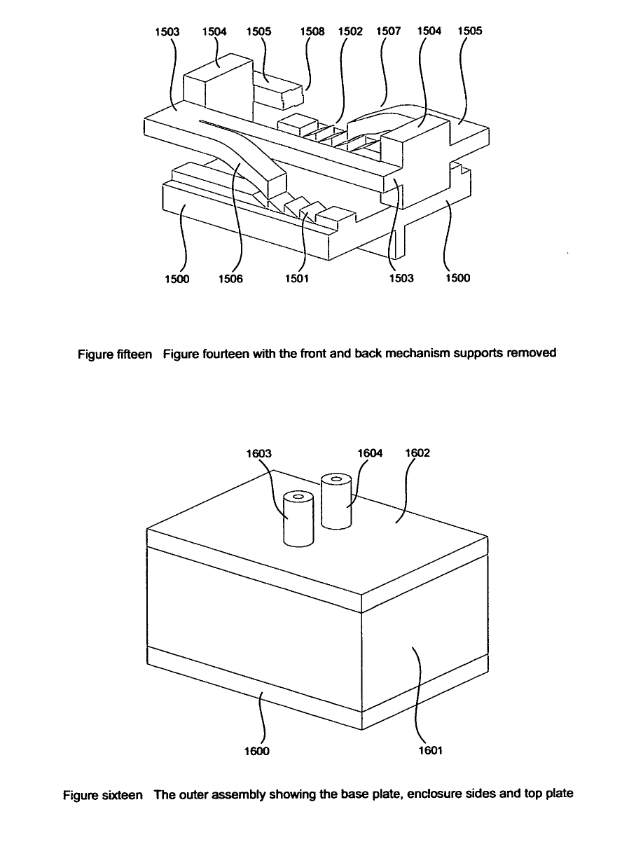

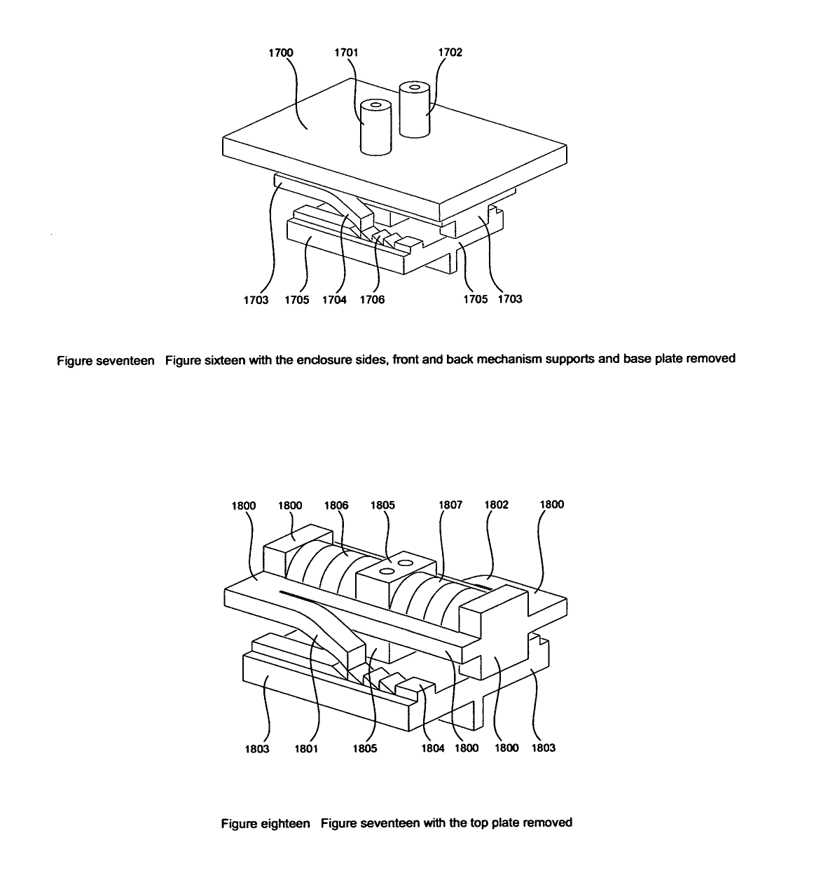

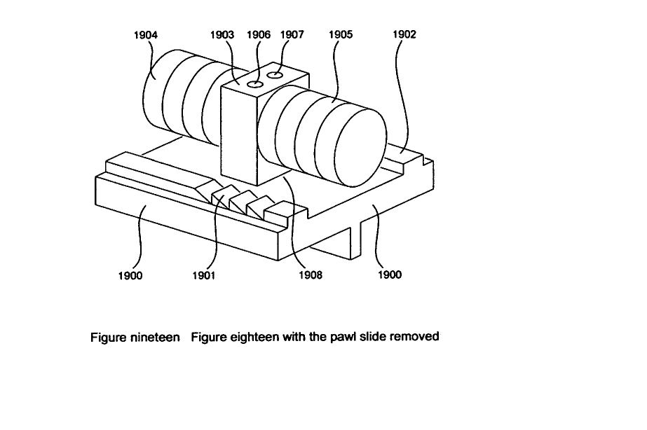

In particular, such new transformers can improve MRI system performance. This requires additional new art because MRI systems demand components which are not ferromagnetic, which do not produce spurious MR signals and which add very little noise to received RF signals.

In various embodiments, these new transformers are comprised of remotely-controlled variable capacitors and inductors which are connected in networks between antenna element outputs and their following LNA inputs. These new step-programmable inductors and capacitors can be either electrically or pneumatically actuated. Pneumatic or electrostatic actuation will in general be particularly useful for application in MRI systems.

### CROSS-REFERENCE TO RELATED APPLICATIONS

None

### STATEMENT REGARDING FEDERALLY SPONSORED RESEARCH OR DEVELOPMENT

None

### NAMES OF THE PARTIES TO A JOINT RESEARCH AGREEMENT

None

### REFERENCE TO A “SEQUENCE LISTING,” A TABLE OR A COMPUTER PROGRAM ON A COMPACT DISC

None

### BACKGROUND OF THE INVENTION

1. Field of the Invention

This invention adds to the art of radio-frequency signal reception by means of antenna elements which feed low-noise amplifiers.

### Abbreviations

dB decibel
LNA low-noise amplifier
MHz megahertz
MR magnetic resonance
MRI magnetic-resonance imaging
NF noise figure
PCB printed circuit board
Q quality factor
RF radio-frequency or radio-frequency signal
SNR signal-to-noise ratio
Z impedance

2. Description of Related Art

Most RF receiving systems include at least one antenna element followed by an LNA. Systems which employ more than one antenna element normally follow each element with an LNA. An LNA is usually a critical system component because of its strong effect on overall SNR. In order to optimize system SNR, an impedance transformer is usually placed between an antenna-element output and its following LNA input.

In some systems, an antenna element can present a time-variable output impedance to the LNA which follows it. As a result, system SNR cannot be constantly optimal. In order to solve this problem, an adjustable impedance transformer can be placed between a variable-output antenna element and its following LNA.

Existing methods for construction of such impedance transformers are sometimes not satisfactory. In most such cases, frequent repeated manual adjustment of LNA-input impedance transformers is not acceptable or not practical. In some instances, present methods for construction of remotely-controlled or programmable impedance-transformer adjustment can be unusable.

Some types of programmable impedance transformers are controlled electronically. It is not unusual for such programmable transformers to cause unacceptable degradation of system SNR by adding noise to received RF signals. Presently-available programmable transformers which employ mechanical control or switching of passive components add minimal noise to received RF signals. But such devices or tuners are often unacceptably large or expensive. A new compact and economical approach to construction of programmable impedance transformers is needed for some RF-receiving applications.

### BRIEF SUMMARY OF THE INVENTION

New art can be employed to construct step-programmable low-noise RF impedance transformers. For some applications, these new transformer embodiments can be significantly more compact and less expensive than any previously available. Such transformers can be constructed and operated to compensate for variable antenna output impedance as needed to optimize system SNR.

Certain embodiments of such new transformers can improve MRI system performance. This entails development of additional new art. MRI antenna-LNA assemblies require components which are not ferromagnetic, which do not produce spurious MR signals and which add very little noise to received RF signals.

In various embodiments, these new transformers consist of remotely-controlled variable capacitors and inductors which are connected in networks between antenna-element outputs and their following LNA inputs. These new step-programmable inductors and capacitors can be either electrically or pneumatically actuated. Pressurized-gas or piezoelectric actuation will usually be required for application in MRI systems.

### BRIEF DESCRIPTION OF THE DRAWINGS

Figure zero The front page drawing

Figure one A block diagram of a typical antenna element, impedance transformer and LNA

Figure two A general circuit-analysis model for a typical antenna element and its following impedance transformer

Figure three Typical antenna output impedance and optimal source impedance for best LNA SNR at 128 MHz

Figure four Typical variation of transformed antenna output impedance at 128 MHz

Figure five Typical LNA noise circles and variation of antenna output impedance at 128 MHz

Figure six Illustration of a step-programmable inductor and capacitor with a typical antenna element and LNA

Figure seven A pair of coils configured to share magnetic flux

Figure eight A typical embodiment of a cored coil pair with a sliding contactor and terminals on a base

Figure nine Figure eight with the addition of a sliding bi-directional rack or ratchet for contactor positioning

Figure ten A typical embodiment of a base with an enclosure and mechanism supports

Figure eleven Figure ten with the enclosure removed

Figure twelve Figure eleven showing the front mechanism support removed and the contact slider/ratchet in its track

Figure thirteen Figure twelve showing the pawl slider in its track

Figure fourteen Figure thirteen with the front mechanism support in place

Figure fifteen Figure fourteen with the front and back mechanism supports removed

Figure sixteen The outer assembly showing the base plate, enclosure sides and top plate

Figure seventeen Figure sixteen with the enclosure sides, front and back mechanism supports and base plate removed

Figure eighteen Figure seventeen with the top plate removed

Figure nineteen Figure eighteen with the pawl slide removed

### DETAILED DESCRIPTION OF THE INVENTION

### Transformation of Antenna Output Impedance for Best-Possible LNA SNR

A nominal block diagram of a typical RF-receiver front end is shown in Figure one. The free-space RF signal received by an antenna element is to be amplified with the addition of minimal noise for use in a following system. In practice, the impedance of the antenna output signal is generally not optimal for best SNR from the LNA. An impedance-transformation element or network between the antenna element and its following LNA is normally required.

An equivalent general circuit model of an antenna and a following impedance transformer is shown schematically in figure two. A resonant antenna is represented as a series combination of a resistor R1, a capacitor C1 and an inductor L1. A following impedance transformer is represented as a series lossy capacitor C2 and a shunt lossy inductor L2. R1 is used to model all of the loss in the antenna, so L1 and C1 are modeled as being lossless.

This is a common basic implementation of an impedance transformer in such circuits because it provides DC isolation between an antenna and its following LNA. And it is a useful general model since it can accurately predict the performance of a variety of impedance-transformer embodiments.

For best system SNR, an antenna output signal must be presented to its following LNA at or fairly near to a particular known impedance. As an illustration, the antenna output impedance of the nominal circuit model shown in figure two and the known required source impedance for input to a typical following LNA are shown on a standard Smith chart in figure three. An operating frequency of 128 MHz is illustrated. But this illustration is general and is applicable over a wide range of frequencies.

In the illustration of figure three, the output impedance of the antenna is shown on the left as seven ohm at 128 MHz. Typically an antenna is operated at resonance, so its output impedance Zout has no reactive component. In conventional notation, Zout=7+i 0 ohm. The optimal source impedance for best SNR from a typical LNA at 128 MHz is shown on the right as approximately 354 ohm plus a positive reactive component of approximately 52 ohm or Zout=354+i 52 ohm.

The best-SNR source impedance required by a given LNA is variable depending upon the particular embodiment. Also, required best-SNR source impedance will in general change as a function of temperature. Furthermore, unit-to-unit variation within ordinary manufacturing and measurement tolerances will cause some variation of best-SNR source impedance. Overall however, the best-SNR source impedance for a given LNA can generally be relatively well-characterized and is normally known.

In figure two, capacitor C2 and inductor L2 function at 128 MHz to transform the 7+i 0 ohm output impedance of the antenna to the optimal source impedance of 354+i 52 ohm for input to the LNA. At 128 MHz the required value of C2 as shown is 30.9 picofarad and the required value of L2 as 50 nanohenry. As illustrated, this impedance transformation includes the effects of modest loss in the inductor L2 and capacitor C2 circuit models shown in figure two.

### the Effect of Variable Antenna Output Impedance

A problem is encountered if the output impedance of an antenna or antenna element is variable while operation of its following impedance transformer is fixed. This is frequently the case for example in MRI systems. Changes in the effective capacitance and loss of an antenna element cause its resonance frequency to vary over time. As a result, a fixed impedance transformer cannot always provide near-optimal impedance to the input of its following LNA.

For illustration of this effect at 128 MHz, the antenna-model resistance R1 of figure two was varied from 2 to 14 ohm. Also, capacitance C1 of figure two was varied from 21.6 to 40.2 picofarad. For convenience, inductance L1 was held constant since any effect of its variation can be accurately modeled by variation of C1. An operating frequency of 128 MHz was used for illustration. But this description is general and is applicable over a wide range of frequencies and impedances.

These changes in the antenna model at 128 MHz produce a range of variation in its output impedance. And as antenna output impedance moves away from its original value, fixed capacitor C2 and fixed inductor L2 in figure two no longer transform it correctly for best-possible SNR from the following LNA. Instead, a range of variation in the impedance presented to the input of the LNA is created. Mapped onto a Smith chart in figure four, this range of transformed impedance takes the form of a proportionally-distorted rectangle having four worst-case extremes or corners,

As is illustrated in figure four, at the low-resistance and low-capacitance corner (400) Zout=27+i 161 ohm. At the low-R and high-C corner (401) Zout=74−i 169 ohm. At the high-R and low-C corner (402) Zout=63+i 113 ohm. And at the high-R and high-C corner (403) Zout=103−i 18 ohm. The original best-SNR source impedance input to the LNA of 354+i 52 ohm is shown for reference (404).

### LNA Characterization Using Noise Circles.

The SNR of an LNA output normally deteriorates as the source impedance presented to its input is moved away from the optimum value. For a given LNA, contours of constant SNR deterioration can be plotted around the optimum source impedance point on a Smith chart as a function of source impedance presented to the LNA. These contours of constant LNA-added noise or constant NF take the form of circles, commonly called noise circles.

For the typical LNA at 128 MHz whose parameters are illustrated in figures three and four, noise circles are plotted on a Smith chart in figure five. In this illustration, the optimal source impedance point for this LNA at Zout=354+i 52 ohm (500) is shown for reference. And the distorted rectangle defined by the four typical worst-case corners of the transformed antenna output impedance is also shown for reference (501).

For illustration, the smallest noise circle (502) shown in figure five is selected to be the locus of all source impedances which cause LNA NF deterioration of 0.5 dB relative to the best possible LNA NF. LNA NFs resulting from source impedances between the optimum source impedance point and the 0.5-dB noise circle will lie between the best possible LNA NF and that NF plus 0.5 dB. On a Smith chart, SNR deterioration as shown by noise circles plots proportionally though not linearly. So the optimal impedance point (500) is not at the center of the 0.5-dB noise circle (502).

The next, larger noise circle (503) shown in figure five is selected to be the locus of all source impedances which cause deterioration in LNA NF of 1 dB relative to the best possible LNA NF. LNA NFs resulting from source impedances which plot on a Smith chart between the 0.5-dB noise circle and the 1-dB noise circle will lie between the best possible NF plus 0.5 dB and the best possible NF plus 1 dB. Again as is normal, the optimal impedance point (500) is not at the center of the noise circle (503).

In the same way, additional noise circles can be selected and plotted outside of the 0.5-dB and 1-dB contours shown in figure five as performance analysis of a particular system might require. For illustration, MRI system SNR performance requirements are in general relatively stringent. For production of better quality MR images at 128 MHz, it would normally be preferred to keep the source impedance presented to the LNA input well within the 0.5-dB noise circle.

Construction of figure five permits comparison of the illustrated LNA 0.5-dB noise circle (502) with the typical range of impedance variation (501) presented to the LNA input and the optimal source impedance point (500) for best LNA NF. Examination of figure five shows that in this illustration, adjustment of the impedance transformation between the antenna and the LNA is required if LNA output NF is to be maintained within about 0.2 or 0.3 dB of optimal under all conditions.

### Programmable Compensation for Antenna Output-Impedance Changes in Computer-Controlled Systems

For implementation of SNR-optimization algorithms, it is generally sufficient and more straightforward to design and employ capacitors and inductors which are remotely-adjustable in discrete steps rather than being continuously adjustable. Such components can be characterized relatively well. So the effect of their operation in an impedance transformation can be known in advance with acceptable accuracy.

The number and spacing of capacitor and inductor adjustment or tuning steps must usually be specifically designed to meet the requirements of a particular application. In some embodiments, use of only three programmable linear adjustment steps each for a single capacitor and a single inductor can be sufficient. In other embodiments, five or more non-linear steps can be required.

For illustration, each of the antenna output-impedance corners shown in figure four (400,401, 402, 403) can be transformed to the optimum source impedance required by the LNA embodiment at Zout=254+i 52 ohm (404). This can be accomplished by changing the values of inductor L2 and capacitor C2 shown in figure two. All illustrated impedance transformations include the effects of modest loss in the L2 and C2 circuit models.

At the antenna-model low-resistance and low-capacitance corner (originally 402) L2 must be changed to about 32.3 nanohenry and C2 must be changed to about 38 picofarad. These new values for C2 and L2 will transform the antenna low-R and low-C output impedance to the required optimal impedance (404). At the low-R and high-C corner (originally 403) the new values are L2=78.5 nanohenry and C2=27.1 picofarad. At the high-R and low-C corner (originally 400) the new values are L2=79.4 nanohenry and C2=17 picofarad. And at the high-R and high-C corner (originally 401) the new values are L2=34.2 nanohenry and C2=33.4 picofarad.

Determination of these four new sets of C2 and L2 values gives the needed range of C2 and L2 tuning for the typical case at 128 MHz illustrated in figures three, four and five. To cover the needed range of impedance transformations for this example, a programmable inductor is needed which is variable from about 30 to about 80 nanohenry. And a programmable capacitor is needed which is variable from about 15 to about 140 picofarad. These are typical ranges for MRI applications at 128 MHz. However, the principles illustrated are general over a wide range of frequencies and applications.

Capacitor C2 and inductor L2 will in general be satisfactory for MRI applications at 128 MHz if each is programmable in five steps over the required ranges. Normal tolerances must be allowed for ordinary unit-to-unit manufacturing variation of all components and assemblies, including antenna elements and LNAs. In order to reduce the size of C2 and L2, it will generally be necessary to allow some additional tolerance for value inaccuracy also.

However for MRI application as illustrated, combination of all needed tolerance allowances can be adjusted to allow maintenance of LNA NF within about 0.2 or 0.3 dB of optimal. In an MRI system, there is frequently a good deal of coupling between a number of array antenna elements. This can cause LNA tuning to be a complex problem. But computer control permits use of iteration to optimize LNA output SNR for as many receiving channels as desired.

### Construction of Compact and Inexpensive Step-Programmable Inductors and Capacitors

A simplified illustration of a new approach to building variable inductors and capacitors for typical MRI applications at 128 MHz is shown in figure six. In this embodiment, a nominal loop antenna element (600) is shown as a conductor trace on a PCB (601). The antenna output feeds an adjustable impedance transformer composed of a new step-programmable inductor embodiment (602) and a new step-programmable high-voltage capacitor embodiment (603).

The output of the capacitor-inductor network is shown applied to the input of a nominal LNA (604). The removable LNA is shown attached to the PCB by input (605) and output (606) connectors. Some additional components are normally included in such an assembly to adjust resonance and to accomplish coupling, decoupling and mode transformation. For clarity in this illustration, additional components have been omitted.

For MRI application, receiving antenna arrays including their LNAs must frequently fit into relatively constrained volumes. In figure six, the inductor and capacitor are scaled to a somewhat larger size than the LNA. In various embodiments, these new components can be reduced further in size. But as they are miniaturized, their cost can climb to an unacceptable level.

Sizing in a particular application will depend upon detailed cost-versus-performance analysis. For illustration, the scaling shown in figure six has been left conservatively larger. The scaling shown is acceptable relative to the size of nearly all present MRI receiving-antenna arrays. Future MRI antenna compactness requirements may justify increased cost to reduce component size further. The scale of the variable components as illustrated is about 3 cm.

The programmable inductor and capacitor shown in figure six are illustrated as pneumatically actuated (607). In other embodiments, actuation by electrical means may be preferred. Solenoids for example can be used to accomplish programmable adjustment. However for MRI applications, pneumatic actuation will be preferred in virtually every case. Use of solenoid actuators with ferromagnetic cores would almost certainly cause unacceptable image distortion in MRI antenna applications. At present, development of non-magnetic piezoelectric actuators is proceeding rapidly. Future employment of electrostatic actuation is not out of the question.

In the illustrated embodiment, two pneumatic supply lines (607) connect to each step-programmable component. This enables application of separate step-up or step-down control pulses to each component independently. Consequently, full coverage of the required impedance adjustment range can be accomplished. In the illustrated embodiment, gas pressure can be provided by a single pressure source.

This pressure reservoir is maintained at a relatively small differential above ambient pressure. If isolation of the gas system is required by a particular application, a second reservoir can be maintained at ambient pressure. Otherwise, ambient pressure can be obtained by simple venting. Pressurized gas for the illustrated embodiment will normally be supplied by conventional down-regulation of compressed dry nitrogen or dry air. Dry nitrogen can be preferred in applications where corrosion is a concern. Other embodiments may be required for certain applications.

In the illustrated embodiment, pulses of gas pressure are applied and released to change the component electrical values in steps. Each component contains a mechanism which limits changes in its value to either one step up or one step down per actuation cycle. Pneumatic control of each component in the illustrated embodiment is accomplished by changes between three states. These states and their change operations are shown in the table below,

TABLE
Pneumatic control states

| | Higher-inductance | Lower-inductance | |
|---|---|---|---|
| State | gas line | gas line | Actuation |
| One | Neutral/one atmosphere | Neutral/one | None |
| | | atmosphere | |
| Two | High | Neutral/one | Inductance |
| | | atmosphere | step up |
| One | Neutral/one atmosphere | Neutral/one | Reset |
| | | atmosphere | |
| Three | Neutral/one atmosphere | High | Inductance |
| | | | step down |
| One | Neutral/one atmosphere | Neutral/one | Reset |
| | | atmosphere | |

In another embodiment, step pneumatic control can be accomplished by means of a more compact single gas tube instead of a pair connected to each programmable component. For such embodiments, a gas reservoir at pressure below ambient would be required to implement three control states. For most implementations, the use of two gas tubes per component will generally be most economical since such embodiments do not require the additional complication of a low-pressure reservoir.

The necessity to avoid ferromagnetic material in MRI antennas places another constraint on the design of compact programmable inductors. For most applications, a variable inductor is constructed by placing a movable ferromagnetic core in a solenoid coil. This is generally unacceptable near an MRI receiving antenna. Consequently, the range of inductance variation currently available for MRI applications is relatively small. And application of variable inductors in MRI antennas is at present very limited. The new approach to construction of step-programmable inductors described here solves this problem.

The ranges of capacitance and inductance variation available from the components illustrated in figure six have been scaled to compensate for the antenna output-impedance variations plotted in figure four at 128 MHz. The sizes and value ranges of the components will necessarily be different for use at other frequencies. But the described design and construction approach is generally applicable over a substantial frequency range.

Fixed-value non-magnetic high-voltage inductors are presently available as solenoid coils which are compatible with the programmable-inductor size illustrated in figure six. Such inductors range in value up to 100 nanohenry or more. Detailed development work is required to optimize a design for any particular application. But the new construction methods described here are conservative and generally applicable.

Manually-adjustable non-magnetic high-voltage capacitors are presently available in cylindrical form and are compatible with the programmable-capacitor size illustrated in figure six. Such capacitors are adjustable over ranges as broad as 1 to 120 picofard or more. Consequently, new compact step-programmable capacitors can be constructed in a manner analogous to that described here to build variable inductors.

### Construction and Mechanism Details

A pair of solenoid coils can be configured to share much of their magnetic flux. This is illustrated in figure seven. Flux sharing will occur if two parallel conductive coils (700, 701) are wound with the same helicity and the two nearest ends of the pair (702,703) are taken as terminals while the other ends of the pair (704, 705) are connected. This configuration is more compact for a given inductance and has better isolation from external noise than a single solenoid.

In addition, a relatively wide variation of inductance across the terminals (702, 703) of the two-solenoid inductor can be realized if the common connection (704, 705) is movable along the length of the pair. This configuration is illustrated in figure eight. Two conductive solenoid coils (804 in five places) are shown wound on insulating cores (805 in two places.) The cores are designed and constructed to provide proper and consistent electrical performance as well as to provide mechanical strength.

The two solenoids (804 in five places) are shown mounted in parallel on an insulating base plate (800 in two places) for support. The terminal ends of the two solenoids are attached to separate conductive pads on the base (801 in four places.) The common-connection ends of the two solenoids are attached to unconnected conductive pads on the base (803 in three places.) Attachment of the conductors to the pads by spot welding is preferred but conductive adhesive or solder can be used.

The conductive pads at the terminal ends of the solenoids (801 in four places) are attached to or part of conductive wires or strips (802 in three places) which extend through or around the base plate (800 in two places.) These wires or strips (802 in three places) are the terminals of the variable inductor. These terminals provide electrical and mechanical connection of the component to a support or substrate such as a PCB.

A sliding or rolling spring contactor (806) provides a movable conductive connection between the two solenoids. When the spring contactor (806) is moved, the inductance which appears between the component terminals (802 in three places) can be varied over a substantial range. The movable spring contactor (806) is designed and constructed to provide as large and consistent a connection area between the two solenoids as is practical. Also, it must have a satisfactory service life for the required component application. It will usually be fabricated from beryllium-copper alloy.

An actuation mechanism is required to move the spring contactor (806) between the two solenoids (804 in five places) and so provide remote control of inductance variation. This is illustrated beginning with figure nine. A base plate (900 in three places) is shown supporting electrical-connection terminals (901 in two places) and unconnected terminals (902 in two places.) The unconnected terminals (902 in two places) provide additional mechanical but not electrical attachment of the component to a support or substrate such as a PCB.

The solenoid pair (903 in three places) is configured as shown in figure eight with the moveable spring contactor (806) between them. The moveable spring contactor (806) cannot be seen in figure nine. It is obscured by a one-piece sliding bi-directional linear ratchet (904 in three places.) This sliding ratchet (904 in three places) holds the spring contactor (806) in place between the two solenoids (903 in three places.) The ratchet slide (904 in three places) moves the contactor (806) linearly in steps equal to the ratchet tooth pitch.

The ratchet tooth pitch is by design equal to the pitch of the solenoids (903 in three places.) A total of five repeatable contactor (806) positions for back and forth movement are allowed by the ratchet (904 in three places) teeth. This number of positions is determined by the desired number of inductor-variation steps. The spring compression and expansion of the contactor (806) allows it to move between positions and retains it in place at each position. The contactor (806) is held by the ratchet slide (904 in three places) so that the contactor's (806) spring compression and expansion is not constrained.

The ratchet slide (904 in three places) is supported by a mechanical structure as illustrated beginning with figure ten. The same base plate shown in figure nine (900 in three places) is shown in figure ten (1000.) In figure ten a supporting and isolating enclosure (1001) is shown attached to the base plate (1000) to a front mechanism support (1002) and to a rear mechanism support (1003.) Figure eleven shows the same view as figure ten with the enclosure (1001) removed.

Figure eleven shows the base plate (1100) the attached front mechanism support (1101) and the attached rear mechanism support (1102.) The front mechanism support (1101) and the rear mechanism support (1102) include guide slots (1103, 1104, 1105 and 1106.) Two of the guide slots (1103 and 1104) support the bi-directional sliding ratchet (904.) The other two guide slots (1105 and 1106) support a bi-directional sliding linear pawl (not shown in figure eleven) which moves the linear ratchet (904.)

For additional clarity, figure twelve shows the same view as figure eleven with the front mechanism support (1101) removed and the sliding ratchet (1202) in place. In figure twelve the positioning of the rear mechanism support (1201 in three places) relative to the ratchet slide (1202) may be seen. The ratchet slide (1202) is shown in its center position in the rear mechanism support (1201 in three places.) The ratchet slide (1202) is supported and guided by the front mechanism support slot (1103, not shown in figure twelve) and the rear mechanism support slot (1206.)

Figure twelve shows the position of the ratchet slide rear teeth (1204) relative to the rear mechanism-support pawl slot (1205.) The ratchet slide front teeth (1203) are positioned in the same way relative to the front mechanism-support pawl slot (1105, not shown in figure twelve.) As illustrated, the ratchet slide rear teeth (1204) support movement to the left but not to the right. The ratchet slide front teeth (1203) support movement to the right but not to the left.

Figure thirteen shows the same view as figure twelve with the addition of the bi-directional sliding linear pawl (1303 in two places, 1304, 1305, 1308, 1309.) The pawl slide (1303 in two places, 1304, 1305, 1308, 1309) will normally be comprised of molded polymer. In general for economy, all of the illustrated mechanical parts will be molded from one or more types of polymer having in each case the required strength, flexibility and elasticity at the lowest possible cost. For the MRI-application embodiments illustrated, several satisfactory polymers are already in use.

Figure thirteen shows the position of the ratchet slide front teeth (1306) relative to the front pawl tooth (1308.) The ratchet slide rear teeth (1307) are positioned in the same way relative to the rear pawl tooth (1309.) The ratchet slide (1302 in two places) and the pawl slide (1303 in two places, 1304, 1305, 1308, 1309) are shown in their center positions.

As illustrated, the pawl slide (1303 in two places, 1304, 1305, 1308, 1309.) can move the ratchet slide (1302 in two places) two tooth-lengths either to the left or to the right. A pawl tooth (1308, 1309) travels one tooth length before engaging a ratchet slide tooth (1306, 1307.) So there are a total of five inductance-tuning steps for the component as required by the electrical design.

The shaping of the rear mechanism-support pawl slot (1205, 1310) prevents the rear pawl tooth (1309) from moving more than two tooth lengths to the left during a single actuation cycle. At the end of an actuation cycle, the shaping of the rear pawl slot (1205, 1310) also allows the rear pawl tooth (1309) to slide back to its center position. The front mechanism-support pawl slot (1105, not shown in figure thirteen) and the front pawl tooth (1308) function together in the same way to prevent the front pawl tooth (1308) from moving more than two tooth lengths to the right during a single actuation cycle.

The pawl slide includes end plates (1303 in two places) which support actuation either to the left or to the right. These plates are positioned two tooth lengths from the outer enclosure walls (1001, not shown in figure thirteen.) This positioning also prevents movement of the pawl slide (1303 in two places, 1304, 1305, 1308, 1309) more than two tooth lengths either to the left or to the right during an actuation cycle.

For additional clarity, figure fourteen shows the same view as figure thirteen with the front mechanism support (1400) in place and the base plate (1300) removed. The contact slider (1402) and the pawl slider (1403 in four places) are shown in their center positions. The contact slider (1402) is shown positioned in its slots (1404, 1405) in the front mechanism support (1400) and rear mechanism support (1401 in two places.) The pawl slider (1403 in four places) is shown positioned in its slots (1406 in two places, 1407 in two places) in the front mechanism support (1400) and the rear mechanism support (1401 in two places.)

For further clarity, figure fifteen shows the same view as figure fourteen with the front mechanism support (1400) and rear mechanism support (1402 in two places) removed. The rear bar of the pawl slider (1505 in two places) is shown cut away (1508.) This shows the positioning of the rear pawl tooth (1507) relative to the rear contact-slider teeth (1502.) The opposing directionality of the front pawl tooth (1506) and the rear pawl tooth (1507) is apparent. The opposing directionality of the front slider teeth (1501) and rear slider teeth (1502) is also apparent.

A well-supported and consistent actuation mechanism is required between the two pawl-slider end plates (1504 in two places) to move the pawl slider (1503 in two places, 1504 in two places, 1505 in two places) either to the left or to the right. In the illustrated embodiment, pneumatic actuation is employed. This is shown beginning with figure sixteen, which presents the same view as figure ten of the component base plate (1000, 1600) and outer enclosure (1001,1601) and adds the component top plate (1602) to this embodiment illustration

Two pneumatic supply lines (1603, 1604) connect to the component through its top plate (1602.) The top plate (1602) the outer enclosure (1601) the base plate (1600) the front mechanism support (1400) and the rear mechanism support (1401 in two places) are all relatively inflexible and are all firmly connected. Together they provide solid support for consistent actuation of step-up and step-down inductor tuning.

For additional clarity, figure seventeen shows the same view as figure sixteen with the base plate (1600) the outer enclosure (1601) the front mechanism support (1400) and the rear mechanism support (1401 in two places) removed. This permits the contactor slide (1705 in two places) and the pawl slide (1703 in two places) to be seen in their positions relative to the top plate (1700) and the pneumatic supply lines (1701, 1702.)

For further clarity, figure eighteen shows the same view as figure seventeen with the top plate (1700) removed. This shows the positioning of the contactor slide (1705 in two places, 1803 in two places) and the pawl slide (1703 in two places, 1800 in five places) relative to the actuator assembly (1805,1806,1807.) For additional clarity, figure nineteen shows the same view as figure eighteen with the pawl slide (1703 in two places, 1800 in five places) removed.

The actuator assembly is comprised of a center support (1805,1903) and two extending-contracting actuators (1806, 1807, 1904, 1905.) In the embodiment illustrated, each of the actuators (1806, 1807, 1904, 1905) is a one-piece polymer bladder or bellows. Each actuator (1806, 1807, 1904, 1905) is bonded at one end to the center support (1805,1903.) Each of the actuators (1806, 1807, 1904, 1905) can be separately expanded by gas pressure a distance of two contactor-slide (1900 in two places) tooth lengths (1901.)

During an actuation cycle, only one actuator (1806, 1807, 1904, 1905) is inflated at a time. An actuator (1806, 1807, 1904, 1905) at ambient pressure can be compressed a distance of two contactor slide (1900 in two places) tooth lengths (1901.) When an inflated actuator (1806, 1807, 1904, 1905) is opened to ambient pressure, it returns to its neutral-position size.

In some embodiments, the actuators contain springs to center the pawl slider (1800 in five places) after an actuation cycle. In other embodiments, the elasticity of the actuator bladders themselves (1806, 1807, 1904, 1905) is sufficient to return the pawl slider (1800 in five places) to its center position after an actuation cycle.

The center support (1805,1903) is bonded to the component top plate (1700.) Each of the two actuators (1806, 1807, 1904, 1905) is bonded to the center support (1805,1903.) But neither of the actuators (1806, 1807, 1904, 1905) is attached to the pawl slider (1800 in five places.) In the pneumatically-actuated embodiment illustrated, the center support (1805,1903) contains two gas passageways (1906, 1907.) The two separate gas passages (1906, 1907) separately connect the two gas supply tubes (1701, 1702) to the two actuator bladders (1806, 1807, 1904, 1905.) The center support (1805,1903) and top plate (1700) are firmly held in place by the enclosure sides (1601) the base plate (1600) the front mechanism support (1400) and the rear mechanism support (1401 in two places.) Firm support of the actuation mechanism allows consistent remote control of pawl slide (1703 in two places) movement either to the left or to the right two tooth lengths (1901) per actuation cycle. Consequently, operation of the actuator bladders (1904,1905) as described in the table of pneumatic control states causes consistent movement of the contactor slide (1800 in five places) one pawl tooth length (1901) per actuation cycle either to the left or to the right.

### Toroid Inductor Cores

In other embodiments using the approach illustrated, toroid cores can be used in place of parallel solenoid cores to form tunable inductors. Because of better flux sharing, two conductive coils wound on a toroid core will In general have a higher inductance to volume ratio and better isolation than a pair of parallel solenoid coils. However, even though they are somewhat more compact, such embodiments will be more expensive to build than an electrically-equivalent solenoid-pair component.

### Step-Programmable Capacitors

Analogous embodiments of step-programmable cylindrical capacitors can be constructed by application of the same actuation mechanisms illustrated for inductors.

1. A new construction for miniature (or approximately centimeter-scale) remotely-controlled (or programmable) step-variable low-noise inductors which employs linear pneumatic actuation is claimed. The new inductors are comprised of the following elements: two conductors wound on parallel linear ferromagnetic or non-ferromagnetic cores to form solenoid coils; a rolling or sliding contactor which electrically connects the two coils and is free to move between and parallel to them; a bi-directional linear pawl-and-rack ratchet which limits the movement of the contactor at each actuation step; a bi-directional linear pneumatic actuator which moves the contactor; a supporting frame; a protective package; one or more external pneumatic connections to the actuator; and external electrical connections to the variable inductance.

2. A new construction for miniature (or approximately centimeter-scale) remotely-controlled (or programmable) step-variable low-noise inductors which employs rotating pneumatic actuation is claimed. The new inductors are comprised of the following elements: two conductors each wound part way around a ferromagnetic or non-ferromagnetic toroid core; a rolling or sliding contactor which electrically connects the two coils and is free to rotate between them; a bi-directional rotating pawl-and-rack ratchet which limits the movement of the contactor at each actuation step; a bi-directional rotating pneumatic actuator which moves the contactor; a supporting frame; a protective package; one or more external pneumatic connections to the actuator; and external electrical connections to the variable inductance.

3. A new construction for miniature (or approximately centimeter-scale) remotely-controlled (or programmable) step-variable low-noise capacitors which employs linear pneumatic actuation is claimed. The new capacitors are comprised of the following elements: two parallel linear capacitor stacks; a rolling or sliding contactor which electrically connects the two stacks and is free to move between and parallel to them; a bi-directional linear pawl-and-rack ratchet which limits the movement of the contactor at each actuation step; a bi-directional linear pneumatic actuator which moves the contactor; a supporting frame; a protective package; one or more external pneumatic connections to the actuator; and external electrical connections to the variable capacitance.

4. A new construction for miniature (or approximately centimeter-scale) remotely-controlled (or programmable) step-variable low-noise capacitors which employs rotating pneumatic actuation is claimed. The new capacitors are comprised of the following elements: two curved capacitor stacks with separating insulators joined to form a torus or torus-like structure; a rolling or sliding contactor which electrically connects the two capacitor stacks and is free to rotate between them; a bi-directional rotating pawl-and-rack ratchet which limits the movement of the contactor at each actuation step; a bi-directional rotating pneumatic actuator which moves the contactor; a supporting frame; a protective package; one or more external pneumatic connections to the actuator; and external electrical connections to the variable capacitance.

5. Actuation of the devices in claims one through four by means of electrical solenoids instead of pneumatic mechanisms is claimed.

6. Actuation of the devices in claims one through four by means of piezoelectric elements instead of pneumatic mechanisms is claimed.
